(19) United States
(12) Patent Application Publication
(10) Pub. No.: US 2026/0326327 A1
(43) Pub. Date: Oct. 22, 2026

(54) MANUAL VERTICAL-TYPE VEGETABLE AND FRUIT PROCESSING DEVICE

(71) Applicant: GUANGDONG GOLDEN-LIGHT ELECTRIC APPLIANCES CO., LTD., Shunde, Foshan, Guangdong (CN)

(72) Inventor: Shiyong FENG, Shunde, Foshan, Guangdong (CN)

(21) Appl. No.: 19/106,673

(22) PCT Filed: Nov. 9, 2023
(86) PCT No.: PCT/CN2023/130825

§ 371 Date: Feb. 26, 2025

(30) Foreign Application Priority Data
Nov. 10, 2022 (CN) 202222998920.X

(51) Int. Cl. B26D 1/06; B26D 1/03; B26D 3/20; B26D 11/00

(52) U.S. Cl. CPC B26D 1/06; B26D 1/03; B26D 3/20; B26D 11/00; B26D 2210/02

(57) ABSTRACT

A manual vertical-type vegetable and fruit processing device, comprising a housing, a first cutter, a second cutter, and a sliding body that slides back and forth relative to the housing, wherein a feed port and a discharge port are provided in the housing; the first cutter is arranged on the sliding body; the second cutter is arranged on the housing; the first cutter has a first cutting direction, the second cutter has a second cutting direction; and the first cutting direction and the second cutting direction are perpendicular or approximately perpendicular to each other, when vegetables and fruits cut by the first cutter enter the second cutter, the vegetables and the fruits can be cut in a matching manner into various required food material shapes comprising diced food materials, so that the requirements of most types of dishes in terms of food material shapes can be met.

The present disclosure claims the priority of Chinese patent application filed in CNIPA on Nov. 10, 2022, with the present disclosure number of 202222998920.X and the present disclosure name of “MANUAL VERTICAL-TYPE VEGETABLE AND FRUIT PROCESSING DEVICE”, the entire contents of which are incorporated into the present disclosure by reference.

### TECHNICAL FIELD

The present disclosure relates to food processing equipment, in particular to a manual processing device which can be used to cut vegetables, fruits and other food materials.

### BACKGROUND

In daily family life, vegetables and fruits are commonly used food materials in kitchen cooking. Before cooking or eating, an important step is to treat them and process them into the required shape so as to facilitate the next process.

At present, the processing methods of vegetables and fruits include cutting vegetables and fruits directly with knives or cutting vegetables and fruits with the help of mechanical equipment (such as manual vegetable cutter or electric vegetable cutter). The advantage of using cutters directly is that they can cut out various shapes as needed, but this processing method is inefficient and consumes a lot of the operator's physical strength; Although it is fast and convenient to use the electric vegetable cutter, the price of the electric vegetable cutter is high, and the cleaning process of the equipment after use is rather complicated; However, the processing method with a manual vegetable cutter is more efficient, consumes less physical strength of the operator, and allows one to enjoy a certain degree of cooking pleasure. It is currently one of the main ways of processing vegetables and fruits in families.

In the prior art, there is a kind of tool for manually cutting vegetables. For example, Chinese invention patent application with publication number of CN108858317A discloses a “food cutter”, which comprises a housing and a cutting mechanism, wherein one side of the housing is provided with a feed port, and the other side of the housing is provided with a discharge port; the cutting mechanism includes a cutting part and a pushing and pulling part for controlling the reciprocating movement of the cutting part; the cutting part includes a sliding piece, a first cutter and a plurality of second cutters; the sliding piece is connected with the housing in a sliding way; The first cutter and the second cutters are both located on the side of the sliding piece substantially the feed port, and are detachably connected with the sliding piece, the first cutter is parallel to the sliding direction of the sliding piece, and the first cutter is not parallel to the second cutter. The food cutter can cut food into sheets or filaments (strips) by using the first cutter and the second cutter, and the cutting can be realized by driving the sliding piece to slide back and forth by the pushing and pulling part, so that the operation is simple and convenient, and the cutting efficiency is high. However, in kitchen cooking, many dishes need diced (that is, blocky and granular) food materials. The food cutter can only process food into sheets or filaments, but can't process food materials into diced, which can't meet the needs of some dishes.

### SUMMARY

In view of the disadvantages of the prior art, the purpose of the present disclosure is to provide a manual vertical-type vegetable and fruit processing device, which can process vegetables and fruits into sheets, filaments, dices or other shapes as required.

In order to achieve above purpose, one technical solution of the present disclosure is: a manual vertical-type vegetable and fruit processing device, comprising a housing, a first cutter, a second cutter and a sliding body which slides back and forth relative to the housing, and the housing is provided with a feed port and a discharge port, wherein the first cutter is arranged on the sliding body, the second cutter is arranged on the housing, the first cutter has a first cutting direction, and the second cutter has a second cutting direction, and the first cutting direction and the second cutting direction are perpendicular to each other or substantially perpendicular to each other.

Preferably, a plane where a blade of the first cutter is located is a first cutting plane, and the first cutting plane and the second cutting direction are perpendicular to each other or substantially perpendicular to each other.

Preferably, a plane where a blade of the second cutter is located is a second cutting plane, and the second cutting plane and the first cutting plane are perpendicular to each other or substantially perpendicular to each other.

Preferably, the plane where the blade of the second cutter is located at least comprises a second cutting plane and a third cutting plane, and the second cutting plane and the third cutting plane are perpendicular or substantially perpendicular to the first cutting plane respectively.

Preferably, the sliding body is provided with a protruding part to push vegetables and fruits.

Preferably, the protruding part is a wedge-shaped surface arranged behind the first cutter.

Preferably, the second cutter comprises a plurality of blades, and the plurality of blades are arranged perpendicular to each other to form a grid shape.

Preferably, the second cutter comprises a plurality of blades which are arranged in parallel with each other.

Preferably, the first cutter is unremovable and fixedly arranged on the sliding body, and the second cutter is removably arranged on the housing.

Compared with the prior art, the cutting directions of the first cutter and the second cutter in the present disclosure are perpendicular to each other or substantially perpendicular, and when the vegetables and fruits cut by the first cutter enter the second cutter, they can be matched to cut a variety of required food shapes, including diced food, which can meet the requirements of most dishes for food shapes.

### BRIEF DESCRIPTION OF THE DRAWINGS

In the following, the structure of the present disclosure and its beneficial technical effects will be described in detail with the attached drawings and specific embodiments.

FIG. 1 is a perspective view of the present disclosure.

FIG. 2 is a sectional view of a sliding body of the present disclosure along a sliding direction F.

FIG. 3 is a first state diagrams of cutting vegetables and fruits in the present disclosure.

FIG. 4 is a second state diagram of cutting vegetables and fruits in the present disclosure.

FIG. 5 is a third state diagram of cutting vegetables and fruits in the present disclosure.

### DETAILED DESCRIPTION OF THE EMBODIMENTS

In order to make the present disclosure purpose, technical solution and beneficial technical effects of the present disclosure clearer, the present disclosure will be further explained in detail with the appended drawings and specific embodiments. It should be understood that the specific embodiments described in this specification are only for explaining the present disclosure, not for limiting the present disclosure.

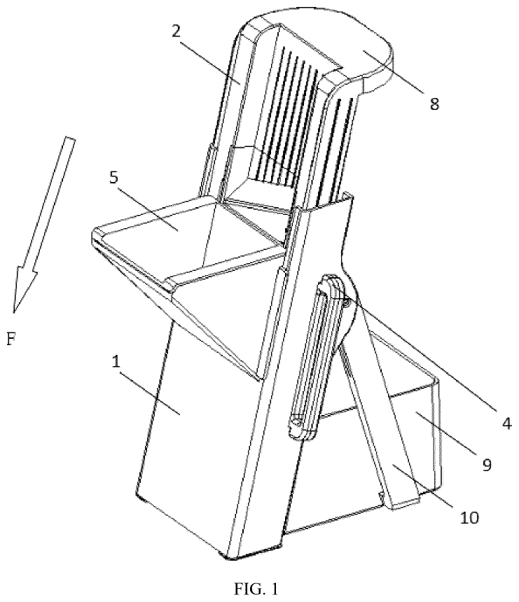

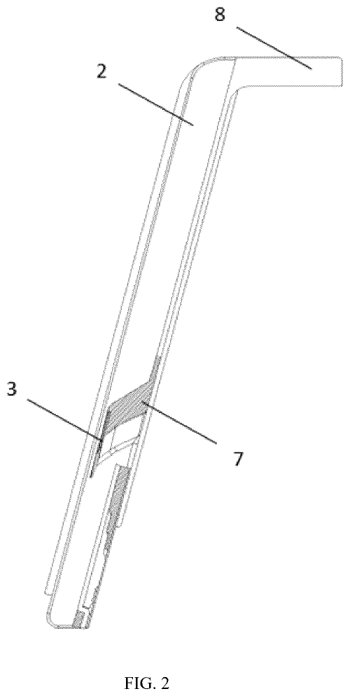

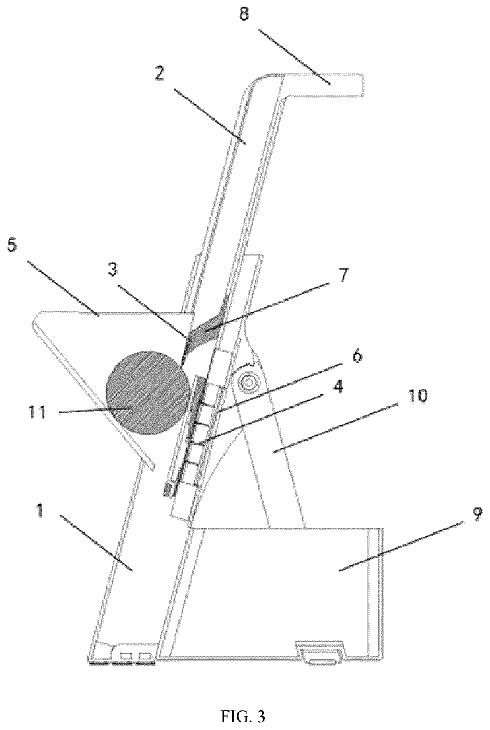

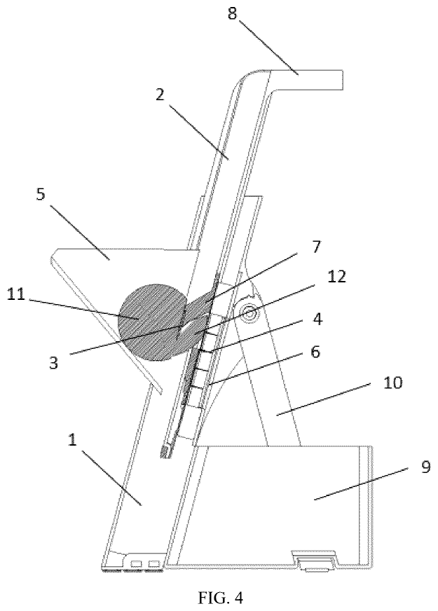

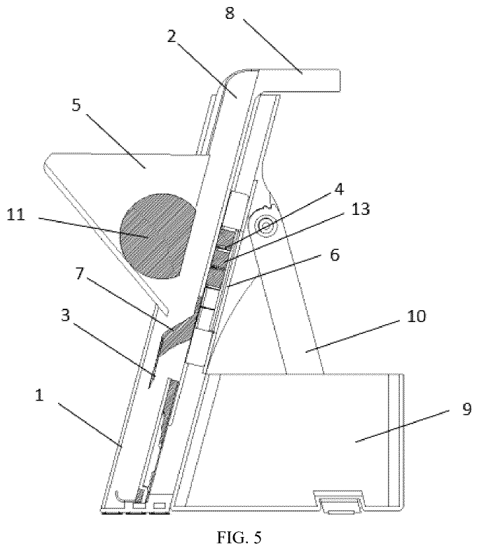

Please refer to FIG. 1 to FIG. 5: a manual vertical-type vegetable and fruit processing device of this embodiment includes a housing 1, a sliding body 2 that slides back and forth relative to the housing 1, a first cutter 3 and a second cutter 4. The housing 1 is provided with a feed port 5 and a discharge port 6. The sliding body 2 is installed in the housing 1, connected with the housing 1 by a common sliding fit mode such as a slide rail or a concave-convex structure, and correspondingly provided with a reset structure such as a spring. The sliding body 1 slides back and forth relative to the housing 1, and the housing 1 is supported by an expandable foot 10. The first cutter 3 is arranged on the sliding body 2, and the second cutter 4 is arranged on the housing 1. The cutting direction of the second cutter 4 is perpendicular to or substantially perpendicular to the cutting direction of the first cutter 3. At one end of the sliding body 2 far away from the feed port 5, there is a pressing part 8 or a pushing and pulling part for pressing by fingers or palms, which is convenient to manually press or push and pull the sliding body 2 to slide. The first cutter 3 feeds to cut vegetables and fruits, etc., to cut out flaky vegetables and fruits. The housing 1 is correspondingly provided with a limiting structure to limit the sliding body 1 to stop at a certain position when the first cutter 3 retracts. The limiting structure can be a common slot structure.

The first cutter 3 has a first cutting direction, which refers to a moving direction of the first cutter relative to the vegetables and fruits when cutting the vegetables and fruits, and the first cutting direction is parallel or substantially parallel to the sliding direction of the sliding body; The second cutter 4 has a second cutting direction, which refers to the moving direction of the second cutter relative to the vegetables and fruits when the vegetables and fruits are cut. The first cutting direction and the second cutting direction are perpendicular or substantially perpendicular to each other. The plane where the blade of the first cutter is located is the first cutting plane, and the first cutting plane and the second cutting direction are perpendicular to each other or substantially perpendicular to each other. The plane where the blade of the second cutter is located is a second cutting plane, and the second cutting plane and the first cutting plane are perpendicular or substantially perpendicular to each other. In some cases, the second cutter includes a plurality of blades, and there may be a plurality of planes where the blades are located, including a second cutting plane, a third cutting plane, etc., which are perpendicular or substantially perpendicular to the first cutting plane, respectively.

The sliding body 2 is provided with a protruding part 7 to push the vegetables and fruits, and the protruding part 7 is arranged behind the first cutter 3, and the protruding part can be set as a wedge-shaped surface, so that when the flaky vegetables and fruits cut by the first cutter 3 are squeezed and pushed, the vegetables and fruits are not easy to be damaged, and it is more convenient to push the vegetables and fruits onto the second cutter 4; The protruding part can also be arranged in a stepped shape or a hillside shape, which is convenient for pushing the fruit and vegetable slices.

The first cutter 3 and the second cutter 4 are arranged between the feed port 5 and the discharge port 6, the first cutter 3 is adjacent to the feed port 5 and the second cutter 4 is adjacent to the discharge port 6; The feed port 5 is arranged outside the first cutter 3, the second cutter 4 is arranged inside the first cutter 3, the discharge port 6 is arranged outside the second cutter 4, and a collection box 9 is arranged below the discharge port 6. Preferably, the first cutter 3 is unremovable and fixedly arranged on the sliding body 2, so that the structure is firmer and good stability can be maintained during use; The cutting direction of the first cutter 3 is parallel or substantially parallel to the sliding direction F of the sliding body 2. The second cutter 4 includes a plurality of blades. When the second cutter 4 is detachably connected with the housing 1, the second cutter 4 is removably connected by a sliding groove on the housing 1, so that different types of cutters can be replaced. The second cutter 4 can have various types of structures: in the first type, a grid structure is formed among a plurality of blades, so that the flaky vegetables and fruits passing through the second cutter are cut into square blocks; in the second type, a plurality of blades are arranged in parallel with each other, so that the flaky vegetables and fruits passing through the second cutter are cut into strips; in other types, a plurality of blades can be combined with other shapes, such as a plurality of star shapes, a plurality of circles and the like, so that the flaky vegetables and fruits passing through the second cutter are cut into corresponding shapes. The blade direction of the first cutter 3 and the blade direction of the second cutter 4 are perpendicular or substantially perpendicular to each other, or the movement of the first cutter 3 makes a movement plane formed by its blade and the plane in which the blade direction of the second cutter 4 is located perpendicular or substantially perpendicular to each other.

When the manual vertical-type vegetable and fruit processing device of this embodiment processes vegetables and fruits, the corresponding second cutter is selected according to the required shape, and if it is to be processed into diced (square) food materials, the grid-like second cutter is inserted into the sliding groove of the housing. Then put the vegetables and fruits (such as potato 11) into the feed port, press the potato to be processed and cut with one hand or with the help of a material cover, and press the pressing part of the sliding body with the other hand, so that the sliding body drives the first cutter to feed, and the blade of the first cutter contacts and cuts the potato, while the blade of the second cutter does not contact the vegetables and fruits; When a first piece of potato is about to be cut (that is, when the cutting by the first cutter is not finished), the protruding part on the sliding body pushes the first piece of potato onto the second cutter, and the second cutter cuts it; The first cutter continues to feed, and the first piece of potato 12 is completely cut off and falls into a space between the first cutter and the second cutter. The protruding part is used to press the potato into the second cutter in a vertical or substantially vertical direction, and the second cutter cuts it into diced potatoes, and the diced potatoes 13 fall into the collection box from the discharge port. Repeat this until the whole potato is cut.

In other embodiments, when the first cutter 3 cuts the vegetables and fruits into strips, the second cutter 4 may be selected with a type in which a plurality of blades are arranged in parallel, and finally the vegetables and fruits are cut into squares (dices).

According to the disclosure and teaching of the above specification, those skilled in the art to which the present disclosure belongs can also make appropriate changes and modifications to the above embodiments. Therefore, the present disclosure is not limited to the specific embodiments disclosed and described above, and some modifications and changes to the present disclosure should also fall within the protection scope of the claims of the present disclosure. In addition, although some specific terms are used in this specification, these terms are only for convenience of description and do not constitute any restrictions on the present disclosure.

1. A manual vertical-type vegetable and fruit processing device, comprising a housing, a first cutter, a second cutter and a sliding body which slides back and forth relative to the housing, and the housing is provided with a feed port and a discharge port, wherein the first cutter is arranged on the sliding body, the second cutter is arranged on the housing, the first cutter has a first cutting direction, and the second cutter has a second cutting direction, and the first cutting direction and the second cutting direction are perpendicular to each other or substantially perpendicular to each other.

2. The manual vertical-type vegetable and fruit processing device according to claim 1, wherein a plane where a blade of the first cutter is located is a first cutting plane, and the first cutting plane and the second cutting direction are perpendicular to each other or substantially perpendicular to each other.

3. The manual vertical-type vegetable and fruit processing device according to claim 2, wherein a plane where a blade of the second cutter is located is a second cutting plane, and the second cutting plane and the first cutting plane are perpendicular to each other or substantially perpendicular to each other.

4. The manual vertical-type vegetable and fruit processing device according to claim 2, wherein the plane where the blade of the second cutter is located at least comprises a second cutting plane and a third cutting plane, and the second cutting plane and the third cutting plane are perpendicular or substantially perpendicular to the first cutting plane respectively.

5. The manual vertical-type vegetable and fruit processing device according to claim 1, wherein the sliding body is provided with a protruding part to push vegetables and fruits.

6. The manual vertical-type vegetable and fruit processing device according to claim 5, wherein the protruding part is a wedge-shaped surface arranged behind the first cutter.

7. The manual vertical-type vegetable and fruit processing device according to claim 1, wherein the second cutter comprises a plurality of blades, and the plurality of blades are arranged perpendicular to each other to form a grid shape.

8. The manual vertical-type vegetable and fruit processing device according to claim 1, wherein the second cutter comprises a plurality of blades which are arranged in parallel with each other.

9. The manual vertical-type vegetable and fruit processing device according to claim 1, wherein the first cutter is unremovable and fixedly arranged on the sliding body, and the second cutter is removably arranged on the housing.
